(19) United States
(12) Patent Application Publication
(10) Pub. No.: US 2024/0403676 A1
(43) Pub. Date: Dec. 5, 2024

(54) COST ESTIMATION DEVICE, METHOD AND PROGRAM FOR ACTION MODEL

(71) Applicant: NIPPON TELEGRAPH AND TELEPHONE CORPORATION, Tokyo (JP)

(72) Inventors: Yasunori AKAGI, Musashino-shi (JP); Hideaki KIN, Musashino-shi (JP); Taichi ASAMI, Musashino-shi (JP)

(73) Assignee: NIPPON TELEGRAPH AND TELEPHONE CORPORATION, Tokyo (JP)

(21) Appl. No.: 18/699,891

(22) PCT Filed: Nov. 9, 2021
(86) PCT No.: PCT/JP2021/041212

§ 371 Date: Apr. 10, 2024

(51) Int. Cl. G06N 7/01

(52) U.S. Cl. CPC G06N 7/01

(57) ABSTRACT

According to one aspect of the present invention, in an action model using a graph, when a cost related to an action is estimated for each of a plurality of sides indicating the action between a plurality of vertices indicating a state, graph data including at least information indicating a structure of the graph and a reward set for the plurality of vertices of the graph is acquired, and action data including a plurality of action trajectories in the graph is acquired. Then, the cost is represented using a parameter, the parameter is estimated using a gradient method related to a likelihood function on the basis of the graph data and the action data, and the estimated parameter is output as an estimated value of the cost.

### TECHNICAL FIELD

One aspect of the present invention relates to a cost estimation device, a method and a program for estimating a cost of an action model for estimating an action of a person, for example.

### BACKGROUND ART

For example, it is important to model an action of a human who tries to achieve a certain goal, such as weight loss by diet or completion of a course of an online class. This is because, by predicting a person's future action and a change in action at the time of intervention on the basis of such modeling, it becomes possible to determine an appropriate intervention measure for supporting the person's achievement of the goal.

By the way, as one of means for such modeling, for example, Non Patent Literature 1 proposes a model based on graph theory. In this model, a state that can be taken by a human is expressed as a vertex, and an action that can be taken by a human in each state is expressed as a side. Further, a cost is set for each side, and this cost represents labor, that is, a load when taking an action. Moreover, a reward is set for each vertex, which represents a reward for reaching a corresponding state.

On this graph, an agent evaluates its own gain for possibilities for trajectories (paths on the graph) of an action that the agent can take in the future, and selects to take an action with the largest gain. The gain of the action trajectory is calculated by weighting to reduce the future cost and increase the immediate cost by a discount scheme called quasi-hyperbolic discount.

This model has attracted attention as being capable of appropriately explaining human actions including irrationality, and has been extended to a model including another bias and the like.

### CITATION LIST

### Non Patent Literature

Non Patent Literature 1: Jon Kleinberg and Sigal Oren, “Time-inconsistent planning: a computational problem in behavioral economics.” In Proceedings of the 15th ACM Conference on Economics and Computation, pages 547-564, 2014.

### SUMMARY OF INVENTION

### Technical Problem

However, in the model described in Non Patent Literature 1, the cost of each side of the graph is treated as a given cost. However, in reality, it is not easy to know in advance the cost of taking an action. Therefore, information necessary for analysis using the model is insufficient, and it is difficult to actually use the model.

The present invention has been made in view of the above circumstances, and an object of the present invention is to provide a technique for enabling estimation of a cost regarding an action that can be taken by a person in an action model using a graph.

### Solution to Problem

To solve the above-described problem, in one aspect of a cost estimation device or a cost estimation method for an action model according to the present invention, in the action model using a graph, when a cost related to an action is estimated for each of a plurality of sides indicating the action between a plurality of vertices indicating a state, graph data including at least information indicating a structure of the graph and a reward set for the plurality of vertices of the graph is acquired, and action data including a plurality of action trajectories in the graph is acquired. Then, the cost is expressed using a parameter, the parameter is estimated using a gradient method related to a likelihood function on the basis of the graph data and the action data, and the estimated parameter is output as an estimated value of the cost.

According to one aspect of the present invention, it is possible to estimate a parameter corresponding to a cost of each side of an action model from, for example, action data representing an observed human action by expressing a cost related to the action by a parameter and applying a gradient method related to a likelihood function to estimation of the parameter. This enables an actual human action analysis using the action model.

### Advantageous Effects of Invention

That is, according to one aspect of the present invention, it is possible to provide a technique capable of estimating a cost of a side that can be taken by a human in an action model using a graph.

### BRIEF DESCRIPTION OF DRAWINGS

FIG. 1 is a block diagram illustrating an example of a hardware configuration of a cost estimation device according to an embodiment of the present invention.

FIG. 2 is a block diagram illustrating an example of a software configuration of the cost estimation device according to the embodiment of the present invention.

FIG. 3 is a flowchart illustrating an example of a processing procedure and processing content of cost estimation processing executed by the cost estimation device illustrated in FIG. 2.

FIG. 4 is a diagram illustrating an example of a configuration of graph data.

FIG. 5 is a table illustrating an example of a reward set at each vertex of the graph illustrated in FIG. 4.

FIG. 6 is a diagram illustrating an example of action trajectories input as action data.

FIG. 7 is a table illustrating an example of parameter estimation results obtained by the cost estimation processing illustrated in FIG. 2.

### DESCRIPTION OF EMBODIMENTS

The following is a description of embodiments according to this invention, with reference to the drawings.

### EMBODIMENT

### (Configuration Example)

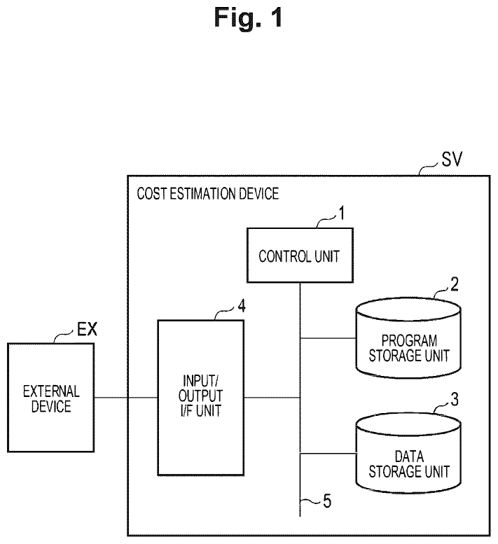

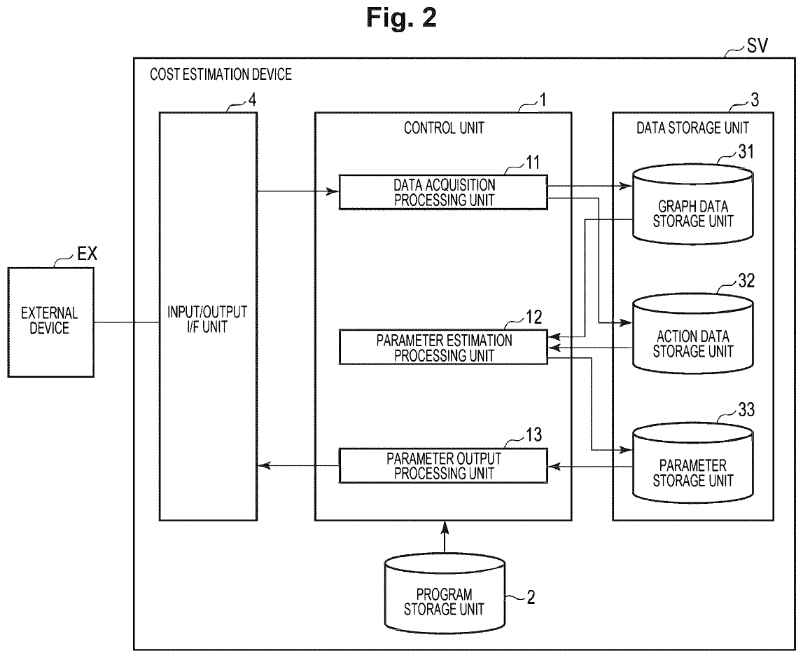

FIG. 1 and FIG. 2 are block diagrams respectively illustrating an example of a hardware configuration and an example of a software configuration of a cost estimation device according to an embodiment of the present invention.

A cost estimation device ML is configured by, for example, a server computer or a personal computer. The cost estimation device ML includes a control unit 1 using a hardware processor such as a central processing unit (CPU), and a storage unit including a program storage unit 2 and a data storage unit 3 and an input/output interface (hereinafter, the interface is referred to as an I/F) unit 4 are connected to the control unit 1 via a bus 5. Note that the cost estimation device ML may include a communication I/F unit that transmits and receives information data to and from a network or the like.

An external device EX used by an administrator or the like is connected to the input/output I/F unit 4 via a signal cable or a network. The input/output I/F unit 4 receives graph data and action data necessary for creating an action model from the external device EX, and outputs a parameter estimated as a cost of a side on the graph by the control unit 1 to the external device EX.

For example, the program storage unit 2 is configured by a combination of a non-volatile memory capable of writing and reading as needed, such as a hard disk drive (HDD) or a solid state drive (SSD), and a non-volatile memory such as a read only memory (ROM) as a storage medium, and stores various programs required for executing various control processes according to an embodiment of the present invention, in addition to middleware such as an operating system (OS).

The data storage unit 3 is configured by a combination of, for example, a non-volatile memory capable of writing and reading as needed, such as an HDD or an SSD, and a volatile memory such as a random access memory (RAM) as storage media, and includes a graph data storage unit 31, an action data storage unit 32, and a parameter storage unit 33 as storage areas required for implementing the embodiment of the present invention.

The graph data storage unit 31 is used to store the graph data input in the external device EX.

The action data storage unit 32 is used to store the action data input in the external device EX.

The parameter storage unit 33 is used to store the parameter estimated by the control unit 1. The parameter indicates the cost of each side of the graph constituting the action model.

The control unit 1 includes a data acquisition processing unit 11, a parameter estimation processing unit 12, and a parameter output processing unit 13, as processing functions according to the embodiment of the present invention.

Each of these processing units 11 to 13 is implemented by causing the hardware processor of the control unit 1 to execute an application program stored in the program storage unit 2. Note that the application program may not be stored in the program storage unit 2 in advance, and may be downloaded from the external device EX or another server device as necessary and stored in the program storage unit 2, for example.

The data acquisition processing unit 11 performs processing of fetching the graph data and the action data input in the external device EX via the input/output I/F unit 4, and causing the graph data storage unit 31 to store the fetched graph data and the action data storage unit 32 to store the fetched action data.

The graph data includes, for example, information indicating a structure of the graph, a start point and an end point on the graph, and a value indicating a reward set for each vertex on the graph. The action data includes a plurality of human action trajectories arbitrarily selected as learning targets. The action trajectory represents an action trajectory (path) of a human on the graph.

The parameter estimation processing unit 12 reads the graph data of the extended probabilistic model from the graph data storage unit 31, and reads the action model from the action data storage unit 32. Then, the parameter estimation processing unit 12 performs processing of estimating the parameter of each side on the graph data on the basis of the read graph data and action data and causing the parameter storage unit 33 to store the estimated parameter.

The parameter output processing unit 13 performs processing of reading the estimated parameter from the parameter storage unit 33 and outputting the read parameter from the input/output I/F unit 4 to the external device EX.

### (Operation Example)

Next, an operation example of a cost estimation device SV configured as described above will be described.

### (1) Action Model Using Graph

First, prior to the description of the operation of the cost estimation device SV according to the embodiment, an outline of a model of Kleinberg and Oren, which is a basis of an action model used in the embodiment of the present invention, will be described.

Now, it is assumed that a directed acyclic graph is defined as G=(V, E), the start point and the end point of the graph are defined as s and t, respectively, and the cost of each side is defined as c: E→R. Note that at least one path exists from the start point s to the end point t. In this case, a naive agent Aβ having a bias parameter β moves from the start point s to the end point t while taking the following action.

That is, when a set of paths from the current vertex v to the end point t is represented as S(v) and the i-th side of a path PES(v) is represented as eᵢ(P), the agent A_{β} selects P as follows and proceeds in the direction of eᵢ(P).

$${P}^{*} ∈ {arg max}_{P ∈ 𝒮 ( v )} C ( P ) \qquad [ Math . 1 ]$$

Note that, expression (P) is as follows.

$$C ( P ) := - c ( {e}_{1} ( P ) ) - β \cdot {\sum }_{i > 1} c ( {e}_{i} ( P ) ) \qquad [ Math . 2 ]$$

Moreover, in a case where a reward is considered, when the i-th vertex of P∈S(v) is vᵢ(P) (where v₀=v), the agent A_{β} selects C′(P) as follows and proceeds in the direction of eᵢ(P).

$$[ Math . 3 ]$$

$${P}^{*} ∈ {arg max}_{P ∈ S ( v )} {C}^{′} ( P )$$

Note that, the C′(P) is as follows.

$$[ Math . 4 ]$$

$${C}^{′} ( P ) := β \cdot {\sum }_{i > 1} r ( {v}_{i} ( P ) ) - c ( {e}_{1} ( P ) ) - β \cdot {\sum }_{i > 1} c ( {e}_{i} ( P ) )$$

Further, in the case where C′(P) is as follows, the agent A_{β} stops proceeding there.

$$[ Math . 5 ]$$

$${arg max}_{P ∈ S ( v )} {C}^{′} ( P ) \leq 0$$

Note that, since the model of Kleinberg and Oren is described in detail in Non Patent Literature 1, detailed description thereof is omitted here.

### (2) Extension to Probabilistic Model

In an embodiment, to make the model using the graph easy to handle, the model is extended to a probabilistic model in advance by the following procedure.

That is, when the agent A_{β} is now represented as A_{α, β, γ} with three parameters α, β, and γ, a vertex existing at present is represented as u, and a set of vertices with a directed side extending from u is represented as N(u), an exponential discount value D(u) for each vertex u∈V is defined as follows.

$$[ Math . 6 ]$$

$$D ( u ) = \{ \begin{matrix}{max}_{v ∈ 𝒩 ( u )} [ {r}_{u} + {c}_{uv} + γ \cdot D ( v ) ] & 𝒩 ( u ) \neq ∅ \\ 0 & 𝒩 ( u ) = ∅\end{matrix} \qquad ( 1 )$$

Since the graph is a directed acyclic graph (DCG), the exponential discount value D(u) is uniquely and inductively determined, and a value thereof can be obtained by dynamic programming described in Algorithm 1.

### [Math. 7]

Algorithm 1 Dynamic programming for calculating D

| | |
|---|---|
| 1: | Topological sort is performed for vertices of graph G = (V, E), |
| | and topological order is set to {u₁, u₂, ..., uₙ} |
| 2: | for i = 1, . . . , n do |
| 3: | D(u) ← rᵤ |
| 4: | for i = n, . . . , 1 do |
| 5: | if [symbol] (uᵢ) = ∅ then |
| 6: | D(uᵢ) ← 0 |
| 7: | else |
| 8: | D(uᵢ) ← D(uᵢ) + cᵤ_{ᵢ}ᵥ + γ · D(v) |

Moreover, for each vertex u∈V, the value Qᵤ(v) is determined by the following expression.

$$[ Math . 8 ]$$

$${Q}_{u} ( v ) := {c}_{uv} + β \cdot D ( v ) . \qquad ( 2 )$$

This value Qᵤ(v) is expressed as a sum of the cost cᵤᵥ of the side from the vertex u toward v and the exponential discount value D(v) of the vertex v weighted by the bias parameter β, as illustrated in the expression (2).

The agent A_{α, β, γ} proceeds to the next vertex v at a probability Tₑ(u, v) on each vertex u. The probability Tₑ(u, v) is expressed as follows.

$$[ Math . 9 ]$$

$${T}_{e} ( u , v ) := \frac{exp ( α \cdot {Q}_{u} ( v ) )}{{\sum }_{v ∈ 𝒩 ( u )} exp ( α \cdot {Q}_{u} ( v ) )}$$

Moreover, a vertex v₀ is newly added to the graph, and a side of the cost 0 is added from all the vertices other than t toward v₀. Then, in a case where the agent A_{α, β, γ} arrives at the vertex t, a task has been achieved, while in a case where the agent A_{α, β, γ} arrives at v₀, the task has not been achieved.

This model is consistent with the original model at α→∞ and γ=1. That is, this model is an extension of the original model including the original model as a subset.

### (3) Operation of Cost Estimation Device SV

The cost estimation device SV according to the embodiment executes cost estimation processing as follows, using the above extended action model as a base.

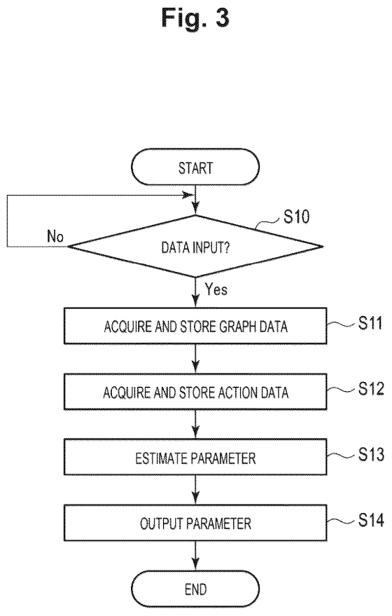

FIG. 3 is a flowchart illustrating an example of a processing procedure and processing content of the cost estimation processing executed by the control unit 1 of the cost estimation device SV.

### (3-1) Acquisition of Data

In step S10, the control unit 1 of the cost estimation device SV monitors input of data necessary for the action model creation processing. When data is input from the external device EX in this state, the control unit 1 of the cost estimation device SV acquires the data input from the external device EX via the input/output I/F unit 4 and causes the data storage unit 3 to store the acquired data in steps S11 and S12 under the control of the data acquisition processing unit 11.

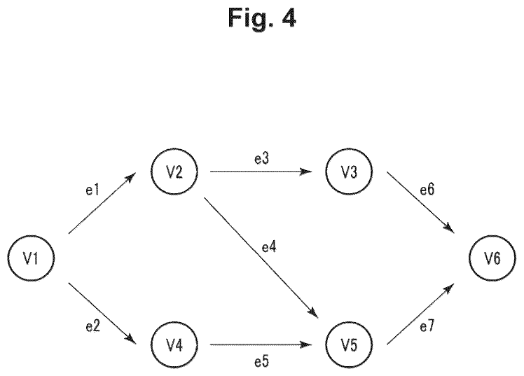

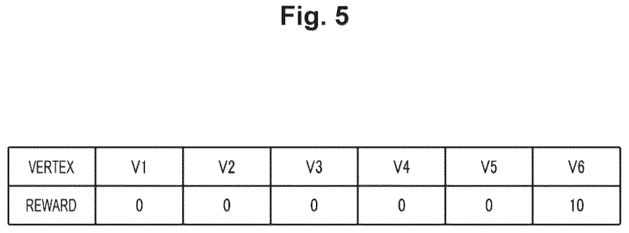

The data input from the external device EX includes the graph data and the action data. As described above, the graph data includes the information indicating the structure of the graph, the start point s and the end point t on the graph, and the value indicating the reward set to each vertex v on the graph. The data acquisition processing unit 11 causes the graph data storage unit 31 in the data storage unit 3 to store the acquired graph data in step S11. FIG. 4 illustrates an example of the structure of the stored graph, and FIG. 5 illustrates an example of the rewards set for the vertices v (v₁, v₂, . . . , v₆) of the graph. Note that the start point s and the end point t are set to the vertices v₁ and v₆ of the graph, respectively.

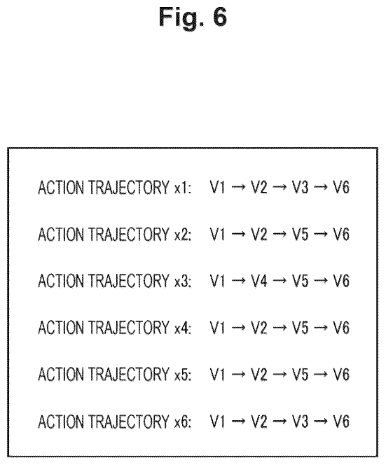

Meanwhile, the action data includes a plurality of human action trajectories. The action trajectory represents an action trajectory (path) of a human on the graph. The data acquisition processing unit 11 causes the action data storage unit 32 in the data storage unit 3 to store the above-described action trajectories in step S12. FIG. 6 illustrates an example of the stored action trajectories.

### (3-2) Estimation of Parameter

Next, the control unit 1 of the cost estimation device SV estimates the cost of each side of the graph as follows in step S13 under the control of the parameter estimation processing unit 12.

That is, a problem of estimating the cost (cᵤᵥ)_{(u, v)}∈E of a plurality of sides when a set X of the above action trajectories is given is considered. Here, the set X includes M action trajectories, and the m-th action trajectory is represented as (u^{m}₁, . . . , u^{m}_{Hm}). Further, the cost cᵤᵥ of each side of the graph is represented as the following expression, using the parameter θ∈R^{d} and the feature vector ξᵤᵥ∈R^{d} allocated to each side (u, v).

$$[ Math . 10 ]$$

$${c}_{uv} = h ( θ , {ξ}_{uv} ) \qquad ( 3 )$$

Therefore, the cost of each side can be estimated by obtaining the parameter θ in the above expression (3).

Now, in the action trajectory set X, when “the number of times of selecting a side toward the vertex v at the vertex u” is fᵤᵥ, the number of times fᵤᵥ is represented as follows.

$$[ Math . 11 ]$$

$${f}_{uv} := {\sum }_{m = 1}^{M} {\sum }_{i = 1}^{{H}_{m} - 1} 𝕀 ( {u}_{i}^{m} = u , {u}_{i + 1}^{m} = v ) \qquad ( 4 )$$

At this time, an occurrence probability P(X|θ) of the action trajectory set X under the parameter θ can be written as follows.

$$[ Math . 12 ]$$

$$P ( 𝒳 \vert θ ) = {\prod }_{u ∈ V} {\prod }_{v ∈ 𝒩 ( u )} {T}_{uv}^{fuv} \qquad ( 5 )$$

Thus, a negative log likelihood L(θ) is set as follows.

$$[ Math . 13 ]$$

$$ℒ ( θ ) := - log P ( 𝒳 \vert θ ) = - {\sum }_{u ∈ V} {\sum }_{v ∈ 𝒩 ( u )} {f}_{uv} \cdot log {T}_{uv} \qquad ( 6 )$$

A problem of minimizing the above is considered.

$$[ Math . 14 ]$$

$$\frac{\partial ℒ ( θ )}{\partial θ} = - {\sum }_{u ∈ V} {\sum }_{v ∈ 𝒩 ( u )} {f}_{uv} \cdot \frac{\partial log {T}_{uv}}{\partial θ} = - {\sum }_{u ∈ V} {\sum }_{v ∈ 𝒩 ( u )} \frac{{f}_{uv}}{{T}_{uv}} \cdot \frac{\partial {T}_{uv}}{\partial θ} \qquad ( 7 )$$

Here, the following expression (8) is used to obtain the following expression (9).

$$[ Math . 15 ]$$

$$\begin{matrix}\frac{\partial {T}_{uv}}{\partial θ} = \frac{\partial }{\partial θ} \frac{exp ( α \cdot {Q}_{uv} )}{{\sum }_{w ∈ 𝒩 ( u )} exp ( α \cdot {Q}_{uw} )} \\ = {\sum }_{w ∈ 𝒩 ( u )} [ \frac{\partial }{\partial {Q}_{uw}} \frac{exp ( α \cdot {Q}_{uv )}}{{\sum }_{w ∈ 𝒩 ( u )} exp ( α \cdot {Q}_{uw} )} \cdot \frac{\partial {Q}_{uw}}{\partial θ} ] \\ = α {T}_{uv} ( \frac{\partial {Q}_{uv}}{\partial θ} - {\sum }_{w ∈ 𝒩 ( u )} {T}_{uw} \cdot \frac{\partial {Q}_{uw}}{\partial θ} )\end{matrix} \qquad ( 8 )$$

$$[ Math . 16 ]$$

$$\begin{matrix}\frac{\partial ℒ ( θ )}{\partial θ} = - {\sum }_{u ∈ V} {\sum }_{v ∈ 𝒩 ( u )} \frac{{f}_{uv}}{{T}_{uv}} \cdot \frac{\partial {T}_{uv}}{\partial θ} \\ = - α {\sum }_{u ∈ V} {\sum }_{v ∈ 𝒩 ( u )} {f}_{uv} ( \frac{\partial {Q}_{uv}}{\partial θ} - {\sum }_{w ∈ 𝒩 ( u )} {T}_{uw} \cdot \frac{\partial {Q}_{uw}}{\partial θ} )\end{matrix} \qquad ( 9 )$$

Thereafter, it is sufficient to obtain ∂Qᵤᵥ/∂θ for arbitrary (u, v)∈E. That is, from the above expression (2), the following expression is obtained.

$$[ Math . 17 ]$$

$$\frac{\partial {Q}_{uv}}{\partial θ} = \frac{\partial h ( θ , {ξ}_{uv} )}{\partial θ} + β \cdot \frac{\partial D ( v )}{\partial θ} \qquad ( 10 )$$

From the expression (1), the following expression is obtained.

$$[ Math . 18 ]$$

$$\frac{\partial D ( u )}{\partial θ} = \{ \begin{matrix}\frac{\partial h ( θ , {ξ}_{u , next ( u )} )}{\partial θ} + γ \cdot \frac{\partial D ( next ( u ) )}{\partial θ} & 𝒩 ( u ) \neq ∅ \\ 0 & 𝒩 ( u ) = ∅\end{matrix} \qquad ( 11 )$$

Note that, next (u) is as follows.

$$[ Math . 19 ]$$

$$next ( u ) := {arg max}_{v ∈ 𝒩 ( u )} \{ {r}_{u} + {c}_{uv} + γ \cdot D ( v ) \}$$

Further, in a case where there is a plurality of v∈N(u) that achieve the maximum value, v∈N(u) with the smallest index is selected. From the expression (11), ∂D(u)/∂θ can also be calculated by dynamic programming. The calculation method is illustrated below as Algorithm2.

### [Math. 20]

$Algorithm 2 Dynamic programming for calculating \frac{\partial D ( u )}{\partial θ}$

| | |
|---|---|
| 1: | Topological sort is performed for vertices of graph G = (V, E), |
| | and topological order is set to {u₁, u₂, . . . , uₙ} |
| 2: | for i = 1, . . . , n do |
| 3: | $\frac{\partial D ( i )}{\text{?}} ← 0$ |
| 4: | for i = n, . . . , 1 do |
| 5: | if [symbol] (uᵢ) = ∅ then |
| 6: | $\frac{\partial D ( {u}_{i} )}{\text{?}} ← 0$ |
| 7: | else |
| 8: | $\frac{\partial D ( \text{?} )}{\partial θ} ← \frac{\partial h ( θ \text{?} )}{\partial θ} + γ \cdot \frac{\partial D ( next ( {u}_{i} ) )}{\partial θ}$ |

$\text{?} \text{indicates text missing or illegible when filed}$

To summarize the above, the algorithm for estimating the parameter θ can be described as the following Algorithm 3.

### [Math. 21]

Algorithm 3 Algorithm for estimating θ

| | |
|---|---|
| 1: | Parameters: Step size η > 0, Constant for convergence |
| | determination ϵ > 0 |
| 2: | Topological sort is performed for vertices of graph G = (V, E), and |
| | topological order is set to {u₁, u₂, . . . , uₙ} |
| 3: | Initialize θ |
| 4: | while True do |
| 5: | $Calculate \frac{\partial D ( u )}{\partial θ} for ∀ u ∈ V by Algorithm 2$ |
| 6: | $Calculate \frac{\partial L ( θ )}{\partial θ} by ( 9 ) and ( 10 )$ |
| 7: | ${θ}_{new} ← θ - η \cdot \frac{θ L ( \text{?} )}{\text{?}}$ |
| 8: | if L(θ_{new}) > L(θ) − η then |
| 9: | return θ |
| 10: | θ ← θ_{new} |

$\text{?} \text{indicates text missing or illegible when filed}$

Calculation of ∂L(θ)/θθ becomes a bottleneck in a calculation amount per gradient calculation. Therefore, calculation can be performed with O(d(|V|+|E|)).

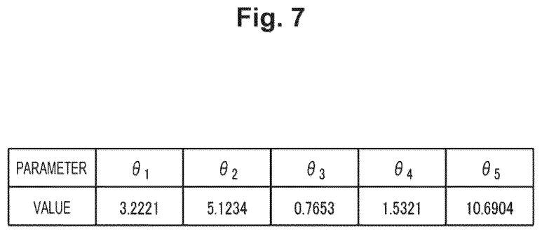

Thus, the parameter θ can be estimated. The parameter estimation processing unit 12 causes the parameter storage unit 33 to store the parameter θ estimated as described above. FIG. 7 illustrates an example of the parameter θ stored in the parameter storage unit 33.

### (3-3) Parameter Output

When the parameter estimation processing ends, the control unit 1 of the cost estimation device SV reads the parameter θ from the parameter storage unit 33 and outputs the read parameter θ from the input/output I/F unit 4 to the external device EX in step S14 under the control of the parameter output processing unit 13.

The external device EX sets the cost for each corresponding side of the separately stored action model on the basis of the parameter θ given from the cost estimation device SV. Therefore, the external device EX can estimate an action of a human using the action model in which the cost is set thereafter.

### (Actions and Effects)

As described above, in an embodiment, in the action model using a graph, when the cost of each side of the graph is estimated, the graph data including the structure of the graph of the action model, the information for designating vertices as the start point and the end point, and the reward set for each vertex is acquired, and the plurality of observed human action trajectories is acquired. Then, the parameter estimation processing unit 12 represents the cost using a parameter, estimates the parameter using a gradient method related to a likelihood function on the basis of the graph data and the action data, and outputs a result thereof by the parameter output processing unit 13.

Therefore, according to an embodiment, it is possible to estimate the parameter corresponding to the cost of the human from, for example, the action data indicating the observed action of the human. This enables an actual human action analysis using the action model.

### Other Embodiments

(1) In the above-described embodiment, a case where the processing of extending the action model into the probabilistic model is performed in advance by another device such as the external device EX has been described as an example. However, the cost estimation device SV may be provided with the processing function to extend the action model into the probabilistic model. In this case, the cost estimation device SV generates the extended probabilistic model including the original model as a subset on the basis of, for example, the graph data acquired from the external device EX.

(2) In the above-described embodiment, a case where the cost estimation device SV is provided independently of the external device EX has been described as an example. However, the embodiment not limited thereto, and each function of the cost estimation device SV may be provided in the external device EX. Thereby, for example, the external device can collectively perform all pieces of the action model creation processing including the cost estimation processing.

(3) In addition, the configuration of the cost estimation device, the processing procedure and processing content of the parameter estimation processing, and the like can be variously modified and implemented without departing from the gist of the present invention.

Although the embodiments of the present invention have been described in detail above, the above description is merely an example of this invention in all respects. It is needless to say that various improvements and modifications can be made without departing from the scope of this invention. That is, a specific configuration according to the embodiments may be appropriately adopted to carry out this invention.

In short, the present invention is not limited to the above-described embodiments without any change, and can be embodied by modifying the constituent elements without departing from the concept of the invention at the implementation stage. In addition, various inventions can be formulated by appropriately combining a plurality of the constituent elements disclosed in the above-described embodiments. For example, some constituent elements may be omitted from the entire constituent elements described in the embodiments. Furthermore, the constituent elements in different embodiments may be appropriately combined.

### REFERENCE SIGNS LIST

ML Cost estimation device
EX External device
1 Control unit
2 Program storage unit
3 Data storage unit
4 Input/output I/F unit
5 Bus
11 Data acquisition processing unit
12 Parameter estimation processing unit
13 Parameter output processing unit
31 Graph data storage unit
32 Action data storage unit
33 Parameter storage unit

1. A cost estimation device for an action model for estimating a cost related to an action for each of a plurality of sides indicating the action between a plurality of vertices indicating a state in the action model using a graph, the cost estimation device comprising a processor including a hardware, configured to
acquire graph data including at least information indicating a structure of the graph and a reward set for the plurality of vertices of the graph;
acquire action data including a plurality of action trajectories in the graph;
express the cost using a parameter, and estimates the parameter using a gradient method related to a likelihood function on a basis of the graph data and the action data; and
output the estimated parameter as an estimated value of the cost.

2. The cost estimation device for an action model according to claim 1, wherein:
the processor further is configured to extend the action model into a probabilistic action model including the action model as a subset, and
when the processor acquires the graph data and the action data, the processor acquires the graph data and the action data corresponding to the probabilistic action model.

3. A cost estimation method for an action model for estimating a cost related to an action for each of a plurality of sides indicating the action between a plurality of vertices indicating a state in the action model using a graph, the cost estimation method comprising:
a process of acquiring graph data including at least information indicating a structure of the graph and a reward set for the plurality of vertices of the graph;
a process of acquiring action data including a plurality of action trajectories in the graph;
a process of expressing the cost using a parameter, and estimating the parameter using a gradient method related to a likelihood function on a basis of the graph data and the action data; and
a process of outputting the estimated parameter as an estimated value of the cost.

4. A non-transitory tangible computer-readable storage medium storing a program for causing a hardware processor included in a cost estimation device for estimating a cost related to an action for each of a plurality of sides indicating the action between a plurality of vertices indicating a state in the action model using a graph,
acquiring graph data including at least information indicating a structure of the graph and a reward set for the plurality of vertices of the graph;
acquiring action data including a plurality of action trajectories in the graph;
expressing the cost using a parameter and estimating the parameter using a gradient method related to a likelihood function on a basis of the graph data and the action data; and
outputting the estimated parameter as an estimated value of the cost.
